(19) United States
(12) Patent Application Publication
(10) Pub. No.: US 2009/0268008 A1
(43) Pub. Date: Oct. 29, 2009

(54) MEDIA CONFERENCE SWITCHING IN A MULTI-DEVICE CONFIGURATION

(75) Inventor: Kirk Topits, San Jose, CA (US)

Correspondence Address: Stolowitz Ford Cowger LLP, 621 SW Morrison St, Suite 600, Portland, OR, 97205, US

(73) Assignee: CISCO TECHNOLOGY INC., San Jose, CA (US)

(21) Appl. No.: 12/109,323

(22) Filed: Apr. 24, 2008

(51) Int. Cl. H04N 7/14

(52) U.S. Cl. 348/14.09; 709/204; 348/E07.084

(57) ABSTRACT

The network communication system includes a network interface to receive audio confidence levels for multiple participants in a conference from one or more multipoint devices, each multipoint device to connect one or more of the participants to the conference. The network communication system further includes a switching controller to select at least one of the participants to provide a contribution to the conference based, at least in part, on the received audio confidence levels, and to provide switching information to the one or more multipoint devices via the network interface, the switching information to prompt the multipoint devices to provide the contribution of the selected participant to non-selected participants of the conference.

### FIELD OF THE INVENTION

This invention relates generally to network communications.

### BACKGROUND

Video conferencing, i.e., the exchange of audio and video data between participants, is becoming an increasingly popular form of communication. During a typical video conference, each participant receives an audio and video feed associated with a current speaker in the conference. When another participant contributes to the conference, the audio and video feed associated with newly contributing participant is presented to the other participants, switching away from the feed of the previous speaker. In an effective video conference, all participants will receive similar experiences, i.e., they will all receive the same (or similar) audio and video data with appropriate feed switching, thus allowing each participant to contribute to the conference.

Many video conferencing schemes utilize a single multipoint device to connect participants or conference endpoints for the exchange of audio and video data. This single multipoint device configuration allows each conference endpoint to receive the same (or similar) video conferencing experience, i.e., receive the audio and video data associated with a current speaker during the video conference. When these conference endpoints are geographically separated, however, the consumption of bandwidth and associated cost of these video conferences dramatically increases.

In an attempt to reduce excessive bandwidth consumption experienced in these single device configurations, some schemes have serially linked several multipoint devices together. Commonly, however, the linking of multipoint devices results in a de facto broadcast by one participant, not a desired interactive video conference.

### DESCRIPTION OF THE DRAWINGS

FIG. 1 illustrates an example system in a multi-device configuration implementing media conference switching.

FIG. 2 illustrates an example master multipoint conferencing device implementing media conference switching in the multi-device configuration shown in FIG. 1.

FIG. 3 shows an example slave multipoint conference device implementing media conference switching in the multi-device configuration shown in FIG. 1.

FIG. 4 shows an example flowchart for embodiments of media conference switching in a multi-device configuration.

FIG. 5 shows another example flowchart for embodiments of media conference switching in a multi-device configuration.

### DETAILED DESCRIPTION

### Overview

In network communications, a device includes a network interface to receive audio confidence levels for multiple participants in a conference from one or more multipoint devices, each multipoint device to connect one or more of the participants to the conference. The network communication system further includes a switching controller to select at least one of the participants to provide a contribution to the conference based, at least in part, on the received audio confidence levels, and to provide switching information to the one or more multipoint devices via the network interface, the switching information to prompt the multipoint devices to provide the contribution of the selected participant to non-selected participants of the conference. Embodiments will be described below in greater detail.

### DESCRIPTION

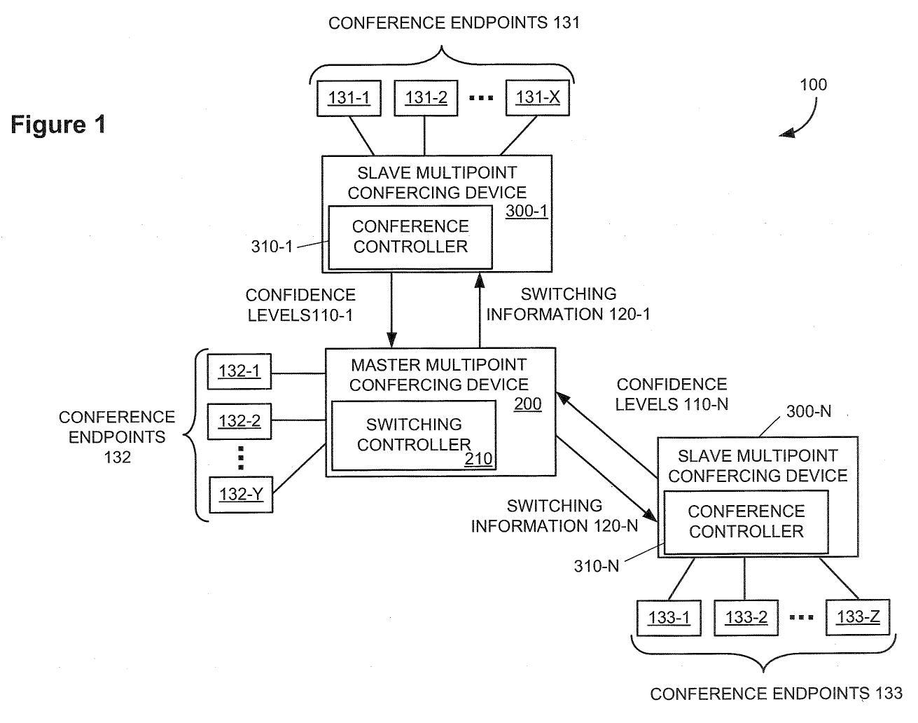

FIG. 1 illustrates an example system 100 in a multi-device configuration implementing media conference switching. Referring to FIG. 1, the system 100 includes multiple conference endpoints 131-133 that utilize a plurality of multipoint conferencing devices 200 and 300-1 to 300-N to engage in a media or video conference. The conference endpoints 131-133 may connect to the media conference via at least one of the multipoint conferencing devices 200 and 300-1 to 300-N and may exchange audio and/or video data with each other as dictated by the multipoint conferencing devices 200 and 300-1 to 300-N. In some embodiments, the multipoint conferencing devices 200 and 300-1 to 300-N may be arranged in a star-configuration with a master-slave relationship to manage media content exchange and participant switching among conference endpoints 131-133 during the media conference.

The multipoint conference devices 200 and 300-1 to 300-N may be tele-presence IP-based video switching systems (TVSW), or any other conferencing device that can at least partially facilitate a media conference between conference endpoints 131-133. The multipoint conference devices 200 and 300-1 to 300-N may communicate with each other and the conference endpoints 131-133 over one or more communication networks, such as circuit-switched networks or packet-switched networks.

The system 100 includes a master multipoint conferencing device 200 and a plurality of slave multipoint conferencing devices 300-1 to 300-N to facilitate the media conference between conference endpoints 131-133. The master multipoint conferencing device 200 may be predetermined, for example, by a network administrator, or may be dynamically selected among the multipoint conference devices 200 and 300-1 to 300-N according to one or more of the following: processing capabilities and/or capacity, bandwidth consumption, minimization of latency in audio and video data transfers, and/or a geographic location or proximity of the multipoint conference devices 200 and 300-1 to 300-N. In some embodiments, the multipoint conference devices 200 and 300-1 to 300-N may negotiate with each other to determine which will become the master device(s).

The master multipoint conferencing device 200 and the slave multipoint conferencing devices 300-1 to 300-N may connect one or more conference endpoints 131-133, respectively, to the media conference. For instance, the master multipoint conferencing device 200 may allow conference endpoints 132-1 to 132-Y to connect into the video conference, the slave multipoint conferencing device 300-1 may connect conference endpoints 131-1 to 131-X, and the slave multipoint conferencing device 300-N may connect conference endpoints 133-1 to 133-Z to the video conference.

The conference endpoints 131-133 may include a media capture system (not shown) that captures media feeds or streams from associated participants, and presents media feeds or streams from other conference endpoints 131-133. For instance, the media capture system may include at least one microphone to capture audio data, at least one speaker to present audio data, at least one display panel to present image data, and/or at least one image capture device to capture image data. These endpoints 131-133 may exchange captured media feed, such as audio and video data, via the multipoint conferencing devices 200, and 300-1 to 300-N in the media conference.

In some embodiments, the conference endpoints 131-133 include functionality to generate a speaker confidence level or audio confidence level associated with the conference endpoint 131-133. A speaker or audio confidence level may indicate a probability that a participant associated with the conference endpoint 131-133 intends to auditorily contribute to the video conference.

To generate speaker confidence levels, the conference endpoints 131-133 may measure volume provided at a microphone or other suitable audio capture device and then filter the captured audio to determine whether the captured audio is voice communication. In some embodiments, the captured audio may be filtered to eliminate noise outside of an audible voice frequency range, to provide echo cancellation, etc. This filtering may help ensure a non-contributory noise detected at a conference endpoint 131-133 is not inadvertently provided to other conference endpoints 131-133 in lieu of actual participant contribution.

The conference endpoints 131-133 may provide the speaker confidence levels to a corresponding multipoint conferencing device 200, or 300-1 to 300-N. For instance, conference endpoint 131-X may provide a speaker confidence level to slave multipoint conferencing device 300-1, conference endpoint 132-1 may provide a speaker confidence level to master multipoint conferencing device 200, and conference endpoint 133-2 may provide a speaker confidence level to slave multipoint conferencing device 300-N. The conference endpoints 131-133 may also transfer a media feed, e.g., of audio and/or video data, to the same multipoint conferencing device 200, or 300-1 to 300-N that received the corresponding speaker confidence levels. In some embodiments, this transfer of audio and/or video data may be performed before, substantially co-incident, or subsequent to the transmission of the speaker confidence levels.

The slave multipoint conferencing devices 300-1 to 300-N may forward the speaker confidence levels received from their corresponding conference endpoints 131-133 and to the master multipoint conferencing device 200, for example, as confidence levels 110-1 to 110-N. In some embodiments, the slave multipoint conferencing devices 300-1 to 300-N may selectively eliminate transferring one or more confidence levels 110-1 and 110-N (and associated media stream) to the master multipoint conferencing device 200 when there is a low probability that those conference endpoints 131-133 are attempting to contribute to the media conference. For instance, the slave multipoint conferencing devices 300-1 to 300-N may selectively eliminate speaker confidence levels by comparing them to a preset threshold, by comparing them to other received speaker confidence levels, etc. This selective elimination may reduce bandwidth consumption and processing resources by the master multipoint conferencing device 200.

The slave multipoint conferencing devices 300-1 to 300-N may also transfer a media feed, e.g., audio and/or video data, corresponding to the confidence levels 110-1 to 110-N to the master multipoint conferencing device 200. In some embodiments, this media feed transfer may be performed before, substantially co-incident, or subsequent to the transmission of the confidence levels 110-1 to 110-N.

The master multipoint conferencing device 200 includes a switching controller 210 to analyze the confidence levels 110-1 to 110-N to determine which conference endpoint 131-133 should contribute its media feed to the media conference. The master multipoint conferencing device 200 may provide switching information 120-1 to 120-N to the slave multipoint conferencing devices 300-1 to 300-N indicating which conferencing endpoint 131-133 has been selected to contribute its media feed to the media conference. The master multipoint conferencing device 200 may also route the media feed of the selected conference endpoint to the slave multipoint conferencing device 300-1 to 300-N and to the conference endpoints 132. Embodiments of the master multipoint conferencing device 200 will be shown and described below in greater detail.

The slave multipoint conferencing devices 300-1 to 300-N may include a conference controller 310-1 to 310-N, respectively, to control some of the operations of the slave multipoint conferencing devices 300-1 to 300-N. For instance, the conference controllers 310-1 to 310-N may receive the switching information 120-1 to 120-N from the master multipoint conferencing device 200 and direct an associated media feed to the its corresponding conference endpoints, respectively. The switching information 120-1 to 120-N may indicate a timing of the media feed switching, such that each conference endpoint 131-133 is capable of synchronously switching to the same media feed at substantially the same time, thus helping to ensure each participant in the conference receives substantially the same conferencing experience. Embodiments of the master multipoint conferencing device 200 will be shown and described below in greater detail.

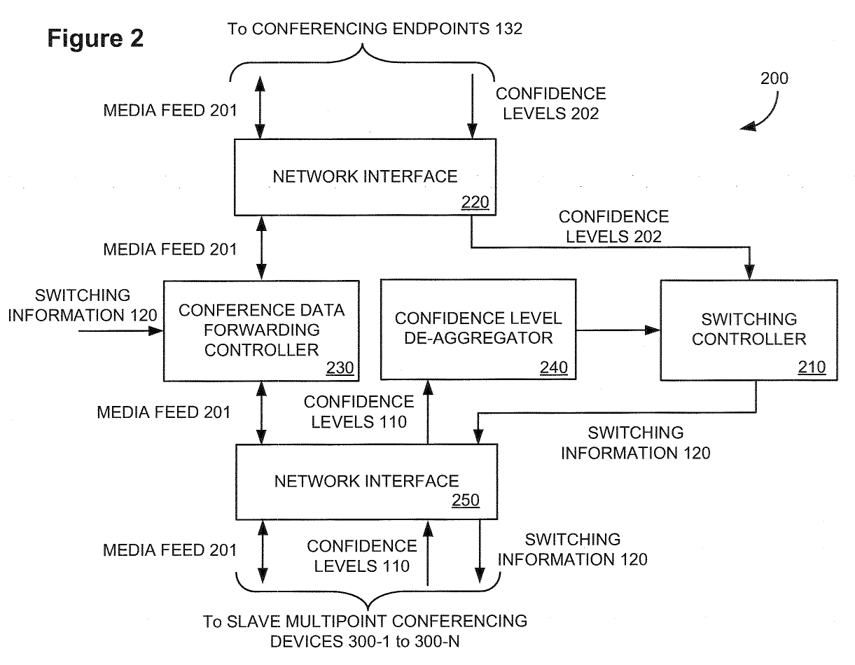

FIG. 2 illustrates an example master multipoint conferencing device 200 implementing media conference switching in the multi-device configuration shown in FIG. 1. Referring to FIG. 2, the master multipoint conferencing device 200 receives confidence levels 110 and associated media feeds 201 from the slave multipoint conferencing devices 300-1 to 300-N via a network interface 250, and receives confidence levels 202 and associated media feeds 201 from the conference endpoints 132 via a network interface 220. The confidence levels 110 and 202 may indicate to the master multipoint conferencing device 200 which of conference endpoints 131-133 (shown in FIG. 1) intend to contribute to the media conference.

The master multipoint conferencing device 200 includes a switching controller 210 to generate switching information 120 responsive to the received confidence levels 110 and 202. The switching information 120 may identify which conference endpoint is selected to contribute its media feed 201 to the media conference, and the timing of the introduction of the media feed 201 to the conference endpoints 131-133. In some embodiments, the switching controller 210 may compare the magnitudes of the confidence levels 110 and 202 to determine a selected conference endpoint, e.g., which participant is speaking the loudest at a conference endpoint 131-133. The switching controller 210 may further introduce some heuristics into the selection of the contributing conference endpoint, for example, by limiting switching a certain period of time after a media feed switch, by weighting speakers or participants according to a predefined importance or according to their recent contributions to or involvement in the media conference, etc.

The master multipoint conferencing device 200 includes a conference data forwarding controller 230 to store and route the media feed 201 associated with the selected conference endpoint, e.g., as identified in the switching information 203, to the conference endpoints 132 via network interface 220 and to the slave multipoint conferencing devices 300-1 to 300-N via network interface 250. In some embodiments, the master multipoint conferencing device 200 may determine to not forward the media feed 201 to the conference endpoint or slave multipoint conferencing device that it received the media feed from in order to reduce consumption of network bandwidth.

In some embodiments, the slave multipoint conferencing devices 300-1 to 300-N may aggregate or combine the confidence levels 110 prior to transfer to the master multipoint conferencing device 200. The master multipoint conferencing device 200 may include a confidence level de-aggregator 240 to separate or de-aggregate the confidence levels 110 received from the slave multipoint conferencing devices 300-1 to 300-N and to provide the de-aggregated confidence levels 110 to the switching controller 210 for analysis.

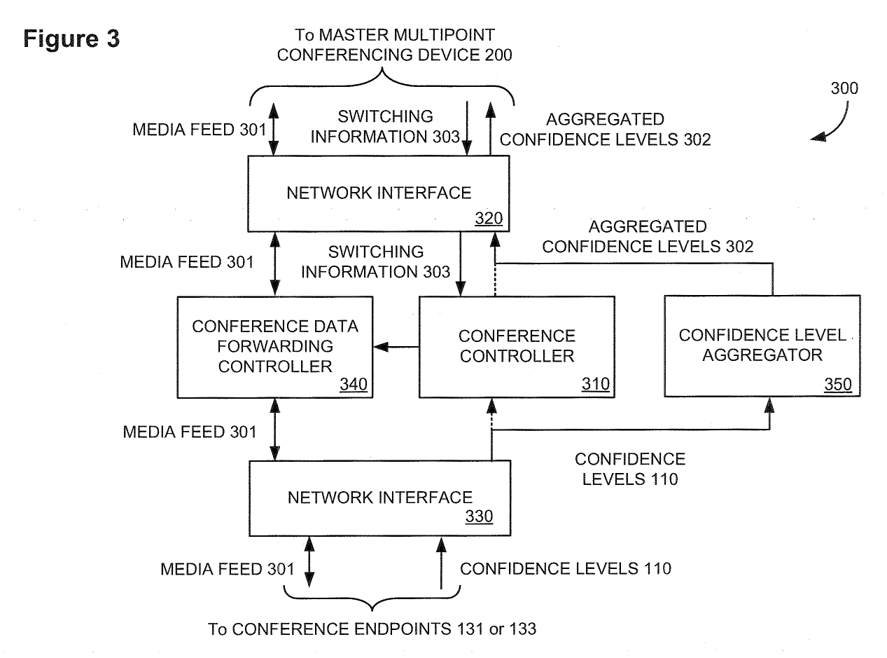

FIG. 3 shows an example slave multipoint conference device implementing media conference switching in the multi-device configuration shown in FIG. 1. Referring to FIG. 3, the slave multipoint conferencing device 300 receives confidence levels 110 and associated media feeds 301 from the conference endpoints 131 or 133 (shown in FIG. 1) via a network interface 330. The confidence levels 110 may indicate which of conference endpoints 131 to 133 intend to contribute to the media conference.

The slave multipoint conferencing device 300 may include a confidence level aggregator 350 to combine or aggregate the confidence levels 110 into aggregated confidence levels 302. The confidence level aggregator 350 may forward the aggregated confidence level 302 to the master multipoint conferencing device 200 via network interface 320. In some embodiments, the slave multipoint conferencing device 300 may provide the confidence levels 110 to the master multipoint conferencing device 200 without aggregation.

The slave multipoint conferencing device 300 may further process and/or analyze the confidence levels 110 prior to forwarding them to the master multipoint conferencing device 200, for example, by removing selected confidence levels 110 that indicate a participant at a conference endpoint 131 or 133 does not intend to speak or contribute to the media conference. This may be accomplished by removing any confidence levels 110 less than a preset threshold, or by comparing the confidence levels 110 with each other.

The slave multipoint conferencing device 300 may include a conference data forwarding controller 340 to store and transmit media feeds 301 to the master multipoint conferencing device 200 via network interface 320. The transmission of the media feeds 301 may be performed prior to, concurrently with, or subsequent to the transmission of the confidence levels to the master multipoint conferencing device 200.

The slave multipoint conferencing device 300 may receive switching information 303 and possibly an associated media feed 301 from the master multipoint conferencing device 200 via the network interface 320. The switching information 303 may indicate that the received media feed 301 is to be displayed at conference endpoints 131 or 133. The slave multipoint conferencing device 300 includes a conference controller 310 to process the switching information 303 and route the received media stream 301 to the conference endpoints 131 or 133. In some embodiments, the conference controller 310 may direct the conference data forwarding controller 340 to forward the received media feed 301 to the associated conference endpoints 131 or 133.

In some embodiments, the switching information 303 may identify which conference endpoint 131 or 133 the master multipoint conferencing device 200 has been selected to contribute to the media conference. When the slave multipoint conferencing device 300 connects to the selected conference endpoint, the master multipoint conferencing device 200 may decide not to send the associated media feed 301 to the slave multipoint conferencing device 300. The slave multipoint conferencing device 300 may receive the media stream 301 from the selected conference endpoint and route the media feed to the other conference endpoints.

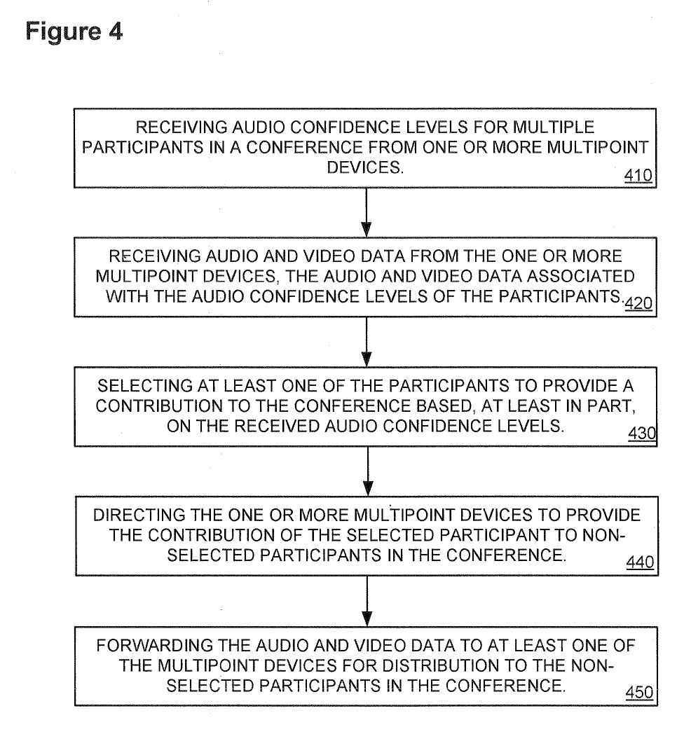

FIG. 4 shows an example flowchart for embodiments of media conference switching in a multi-device configuration. Referring to FIG. 4, at a block 410, the master multipoint conferencing device 200 receives audio confidence levels for multiple participants in a conference from one or more multipoint devices 300-1 to 300-N, each multipoint device 300-1 to 300-N (and optionally 200) to connect one or more of the participants to the conference. The audio confidence levels may indicate an attempt by one or more of the participants in the conference to speak in the conference.

At a block 420, the master multipoint conferencing device 200 receives audio and video data from the one or more multipoint devices 300-1 to 300-N, the audio and video data associated with the audio confidence levels of the participants.

At a block 430, the master multipoint conferencing device 200 selects at least one of the participants to provide a contribution to the conference based, at least in part, on the received audio confidence levels. The contribution by the participant may be the audio and/or video data received by the master multipoint conferencing device 200. In some embodiments, the selection of the participant may be made based, in part, on heuristics of the conference, such as the time since the most recent switch between participants, the importance of the speaker, etc.

At a block 440, the master multipoint conferencing device 200 directs the one or more multipoint devices to provide the contribution, i.e., audio and/or video data, of the selected participant to non-selected participants in the conference. In some embodiments, the master multipoint conferencing device 200 may generate switching information that indicates who the selected participant is and when conference endpoints should switch to a media feed corresponding to the selected participant.

At a block 450, the master multipoint conferencing device 200 forwards the audio and video data to at least one of the multipoint devices for distribution to the non-selected participants in the conference.

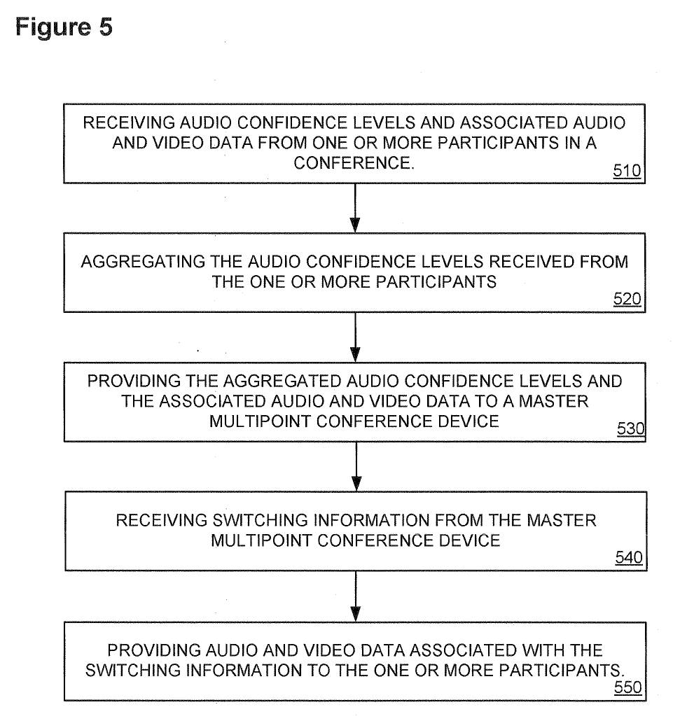

FIG. 5 shows another example flowchart for embodiments of media conference switching in a multi-device configuration. Referring to FIG. 5, at a block 510, the slave multipoint conference device 300 receives audio confidence levels and associated audio and video data from one or more participants in a conference.

At a block 520, the slave multipoint conference device 300 aggregates the audio confidence levels received from the one or more participants. The slave multipoint conference device 300 may analyze the audio confidence levels and selectively remove those who indicated their associated participant is not attempting to contribute or speak in the conference.

At a block 530, the slave multipoint conference device 300 provides the aggregated audio confidence levels and the associated audio and video data to a master multipoint conference device. The transmission of the aggregated audio confidence levels may be performed separately or concurrently with the transmission of the associated audio and video data.

At a block 540, the slave multipoint conference device 300 receives switching information from the master multipoint conference device. The switching information may identify a participant and/or an associated media stream that has been selected by the master multipoint conference device 200 to contribute to the conference. The switching information may also convey a synchronization for switching to or presenting the associated media stream to the participants.

At a block 550, the slave multipoint conference device 300 provides audio and video data associated with the switching information to the one or more participants. The slave multipoint conference device 300 may provide the audio and video data to a conferencing endpoint capable of presenting the audio and video data to the participants. The timing of the presentation to the participants may be controlled or directed by the switching information.

One of skill in the art will recognize that the concepts taught herein can be tailored to a particular application in many other advantageous ways. In particular, those skilled in the art will recognize that the illustrated embodiments are but one of many alternative implementations that will become apparent upon reading this disclosure. Although system 100 is shown in a centralized or star configuration, i.e., with each slave connected directly to the master, system 100 may utilize other configurations to manage the media conference in a multi-device environment. In some embodiments, the system 100 may select multiple masters that can cooperate when providing the media conference to the participants.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A device comprising:
a network interface to receive audio confidence levels for multiple participants in a conference from one or more multipoint devices, each multipoint device to connect one or more of the participants to the conference; and
a switching controller to select at least one of the participants to provide a contribution to the conference based, at least in part, on the received audio confidence levels, and to provide switching information to the one or more multipoint devices via the network interface, the switching information to prompt the multipoint devices to provide the contribution of the selected participant to non-selected participants of the conference.

2. The device of claim 1
where the network interface is operable to receive audio and video data from the one or more multipoint devices, the audio and video data corresponding to the audio confidence levels of the participants; and
where the device includes a conference data forwarding controller to forward the audio and video data to at least one of the multipoint devices for distribution to the non-selected participants in the conference.

3. The device of claim 2 where the switching controller is operable to inform the multipoint device associated with the selected participant of the selection, the informed multipoint device to provide audio and video data to the non-selected participants connected to the conference by the informed multipoint device.

4. The device of claim 1 where the switching controller is operable to select at least one participant to provide a contribution to the conference based on the received confidence levels and switching heuristics associated with the conference.

5. The device of claim 1 including a conference level de-aggregator to de-aggregate an aggregation of audio conference levels received from at least one multipoint device, the switching controller to select at least one of the participants to provide a contribution to the conference based, at least in part, on the de-aggregated audio confidence levels.

6. The device of claim 1 where the audio confidence levels indicate a probability that an associated participant intends to contribute to the conference.

7. The device of claim 1 where the one or more multipoint devices are operable to synchronously present the contribution of the selected participant to the non-selected participants according to the switching information.

8. A method comprising:
receiving audio confidence levels for multiple participants in a conference from one or more multipoint devices, each multipoint device to connect one or more of the participants to the conference;
selecting at least one of the participants to provide a contribution to the conference based, at least in part, on the received audio confidence levels; and
directing the one or more multipoint devices to provide the contribution of the selected participant to non-selected participants in the conference.

9. The method of claim 8 includes
receiving audio and video data from the one or more multipoint devices, the audio and video data corresponding to the audio confidence levels of the participants; and
forwarding the audio and video data to at least one of the multipoint devices for distribution to the non-selected participants in the conference.

10. The method of claim 9 includes informing the multipoint device associated with the selected participant of the selection, where the informed multipoint device is operable to provide audio and video data to the non-selected participants connected to the conference by the informed multipoint device.

11. The method of claim 8 includes selecting at least one participant to provide a contribution to the conference based on the received confidence levels and switching heuristics associated with the conference.

12. The method of claim 8 includes
receiving a confidence level aggregation of from the one or more multipoint devices;
de-aggregating the confidence level aggregation to identify audio confidence levels associated with one or more participants in the conference; and
selecting at least one of the participants to provide a contribution to the conference based, at least in part, on the de-aggregated audio confidence levels.

13. The method of claim 8 where the audio confidence levels indicate a probability that an associated participant intends to contribute to the conference.

14. The method of claim 8 where the one or more multipoint devices to synchronously present the contribution of the selected participant to the non-selected participants responsive to the directing.

15. A system comprising:
a plurality of multipoint conference devices including at least one master conference device and at least one slave conference device, the master conference device to receive audio information corresponding to participant endpoints of the video conference from the slave conference device and to select at least one of the participant endpoints to contribute audio and video data to the video conference based, at least in part, on the received audio information.

16. The system of claim 15 where the master conference device is operable to provide switching information to the slave conference device, where the switching information indicates the selected participant endpoint is a current speaker in the video conference.

17. The system of claim 16 where the slave conference device is operable to provide audio and video data to the master conference device along with the switching information.

18. The system of claim 16
where the master conference device is operable to route the audio and video data associated with the selected participant endpoint to the slave conference device; and
where the slave conference device is operable to provide the audio and video data to the other participant endpoints according to the switching information.

19. The system of claim 15 where at least some of the participant endpoints synchronously present the audio and video data received from at least one of the multipoint conference devices according to the switching information.

20. The system of claim 15 where the master conference device is selected among the plurality of multipoint conference devices according to at least one of a processing capability of the multipoint conference devices, bandwidth consumption between communicating multipoint conference devices, to minimize latency of audio and video data transfer among the multipoint conference devices, or a geographic location of the multipoint conference devices.
